(19) United States
(12) Patent Application Publication
(10) Pub. No.: US 2006/0045151 A1
(43) Pub. Date: Mar. 2, 2006

(54) External cavity wavelength stabilized Raman lasers insensitive to temperature and/or external mechanical stresses, and Raman analyzer utilizing the same

(76) Inventors: Daryoosh Vakhshoori, Cambridge, MA (US); Peidong Wang, Carlisle, MA (US); Masud Azimi, Belmont, MA (US)

Correspondence Address: Mark J. Pandiscio;Pandiscio & Pandiscio, P.C., 470 Totten Pond Road, Waltham, MA, 02451-1914, US

(21) Appl. No.: 11/119,076

(22) Filed: Apr. 29, 2005

Related U.S. Application Data
(60) Provisional application No. 60/605,697, filed on Aug. 30, 2004.

(51) Int. Cl. H01S 3/13; H01S 3/08

(52) U.S. Cl. 372/32; 372/92; 372/102

(57) ABSTRACT

An external cavity wavelength stabilized laser system including a platform, a laser mounted to the platform with a laser mount, a diffractor mounted to the platform with a diffractor mount, and a lens mounted to the platform with a lens mount between the laser and the diffractor so as to transmit light therebetween wherein the wavelength of the laser is determined by (i) the angle of incidence of the light on the diffractor and (ii) the diffraction characteristics of the diffractor and wherein the system components are selected so that (i) a change in the angle of incidence of the light on the diffractor due to a change in the temperature of the system components substantially offsets (ii) a change in the diffraction characteristics of the diffractor.

### REFERENCE TO PENDING PRIOR PATENT APPLICATION

This patent application claims benefit of pending prior U.S. Provisional Patent Application Ser. No. 60/605,697, filed Aug. 30, 2004 by Daryoosh Vakhshoori et al. for METHOD OF PRODUCING EXTERNAL CAVITY FREQUENCY STABILIZED RAMAN LASERS INSENSITIVE TO TEMPERATURE OR EXTERNAL MECHANICAL STRESSES (Attorney's Docket No. AHURA-24 PROV).

The above-identified patent application is hereby incorporated herein by reference.

### FIELD OF THE INVENTION

This invention relates to lasers in general, and more particularly to semiconductor lasers.

### BACKGROUND OF THE INVENTION

Applications using Raman scattering signatures to identify unknown materials is expanding rapidly, e.g., in the areas of security and safety, biotechnology, biomedicine, industrial process control, pharmaceuticals and other markets. This is due to the rich and detailed optical signatures made possible by analyzing Raman scattering off the specimen.

In these Raman analyzers, a laser is used to generate a stable and narrow linewidth light signal which is used as the source of the Raman pump. However, for portable applications, small size and low electrical power consumption efficiency is of the essence. This is because the laser in such a system can account for the majority of the power consumption, and hence dominate the battery lifetime of portable units.

Semiconductor lasers are one of the most efficient lasers known. Semiconductor lasers can have wall-plug efficiencies greater than 50%, which is quite rare for any other type of lasers. However, to wavelength-stabilize the semiconductor lasers that are traditionally used for Raman applications, at 785 nm or other operating wavelengths, the most commonly used technique is to provide a diffraction grating in an external cavity geometry so as to stabilize the wavelength of the laser and narrow its linewidth to few inverse centimeter (<50 cm−1). Since such an arrangement tends to be temperature-sensitive (i.e., temperature changes can cause thermal expansion of various elements of the assembly which can detune the alignment and change laser wavelength and/or linewidth), a thermo-electric cooler is commonly used to stabilize the temperature to within couple of degrees. However, thermo-electric coolers themselves consume substantial amounts of power, making such an arrangement undesirable in portable applications where power consumption is an important consideration.

Thus, there is a need for a low-power laser which can provide a stable, narrow-linewidth-signal without the need for an active temperature-controlling element (for the purposes of the present disclosure, we can consider such a laser as an “uncooled laser”).

In addition to the foregoing, it has also been found that if the platform (or substrate) carrying the system components becomes mechanically deformed or distorted due to temperature induced stress or mechanical stress, the wavelength of the laser can also be affected.

Thus, there is also a need for improved techniques for desensitizing the laser wavelength against the mechanical deformations and distortions of the platform.

### SUMMARY OF THE INVENTION

In accordance with the present invention, it has now been discovered that there are ways to make an external cavity grating laser robust against temperature changes without using “power-hungry” temperature controllers. Furthermore, these same approaches can be used to make a thin-film stabilized laser (i.e., a laser using thin film dispersive filters instead of a grating for wavelength stabilization) robust against temperature changes without using temperature controllers.

Thus, in the present disclosure there are disclosed several different ways to realize “uncooled lasers” which have a sufficiently stable, narrow-linewidth signal as to be useful as a Raman pump source in portable instruments and systems, and in other applications requiring similar features.

And in the present disclosure there are also disclosed improved techniques for desensitizing the laser wavelength against mechanical deformations and distortions.

In one form of the invention, there is provided an external cavity wavelength stabilized laser system comprising:

a platform;

a laser mounted to the platform with a laser mount;

a diffractor mounted to the platform with a diffractor mount; and

a lens mounted to the platform with a lens mount between the laser and the diffractor so as to transmit light therebetween;

wherein the wavelength of the laser is determined by (i) the angle of incidence of the light on the diffractor, and (ii) the diffraction characteristics of the diffractor; and

wherein the system components are selected so that (i) a change in the angle of incidence of the light on the diffractor due to a change in the temperature of the system components substantially offsets (ii) a change in the diffraction characteristics of the diffractor.

In another form of the invention, there is provided a Raman analyzer comprising:

a light source for delivering excitation light to a specimen so as to generate the Raman signature for that specimen;

a spectrometer for receiving the Raman signature of the specimen and determining the wavelength characteristics of that Raman signature; and

analysis apparatus for receiving the wavelength information from the spectrometer and, using the same, identifying the specimen;

wherein the light source comprises an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
wherein the system components are selected so that (i) a change in the angle of incidence of the light on the diffractor due to a change in the temperature of the system components substantially offsets (ii) a change in the diffraction characteristics of the diffractor.

In another form of the invention, there is provided a method for generating light, comprising:

providing an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and

selecting the system components so that (i) a change in the angle of incidence of the light on the diffractor due to a change in the temperature of the system components substantially offsets (ii) a change in the diffraction characteristics of the diffractor.

In another form of the invention, there is provided a method for identifying a specimen, comprising:

delivering excitation light to the specimen so as to generate the Raman signature for that specimen;

receiving the Raman signature of the specimen and determining the wavelength characteristics of that Raman signature; and

identifying the specimen using the wavelength characteristics of the Raman signature;

wherein the excitation light is delivered to the specimen using an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
wherein the system components are selected so that (i) a change in the angle of incidence of the light on the diffractor due to a change in the temperature of the system components substantially offsets (ii) a change in the diffraction characteristics of the diffractor.

In another form of the invention, there is provided an external cavity wavelength stabilized laser system comprising:

a platform;

a laser mounted to the platform with a laser mount;

a diffractor mounted to the platform with a diffractor mount; and

a lens mounted to the platform with a lens mount between the laser and the diffractor so as to transmit light therebetween;

wherein the wavelength of the laser is determined by (i) the angle of incidence of the light on the diffractor, and (ii) the diffraction characteristics of the diffractor; and

wherein the system components are selected so that a change in the position of one element in the system due to a temperature change is offset by a change in the position of another element in the system due to a temperature change so as to substantially maintain the angle of incidence of the light on the diffractor.

In another form of the invention, there is provided a method for generating light, comprising:

providing an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and

selecting the system components so that a change in the position of one element in the system due to a temperature change is offset by a change in the position of another element in the system due to a temperature change so as to substantially maintain the angle of incidence of the light on the diffractor.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts, and further wherein:

FIG. 1 is a schematic illustration showing a typical Littrow external cavity grating stabilized configuration;

FIG. 2 is a schematic illustration showing a thermal expansion mismatch of laser, lens and grating mount changes in the retro-diffraction angle, and compensation of thermal expansion of the grating pitch;

FIG. 3 is a schematic illustration showing a lens mount having a wedge configuration;

FIG. 4 is a schematic illustration showing a side mounted broad area laser with appropriate mount material so as to reduce temperature sensitivity;

FIG. 5 shows a novel means for mounting the laser platform to an external surrounding platform so as to reduce the effect mechanical deformations and distortions; and

FIG. 6 is a schematic view showing a novel Raman analyzer formed in accordance with the present invention.

### DETAILED DESCRIPTION OF THE PREFERRED EMBODIMENTS

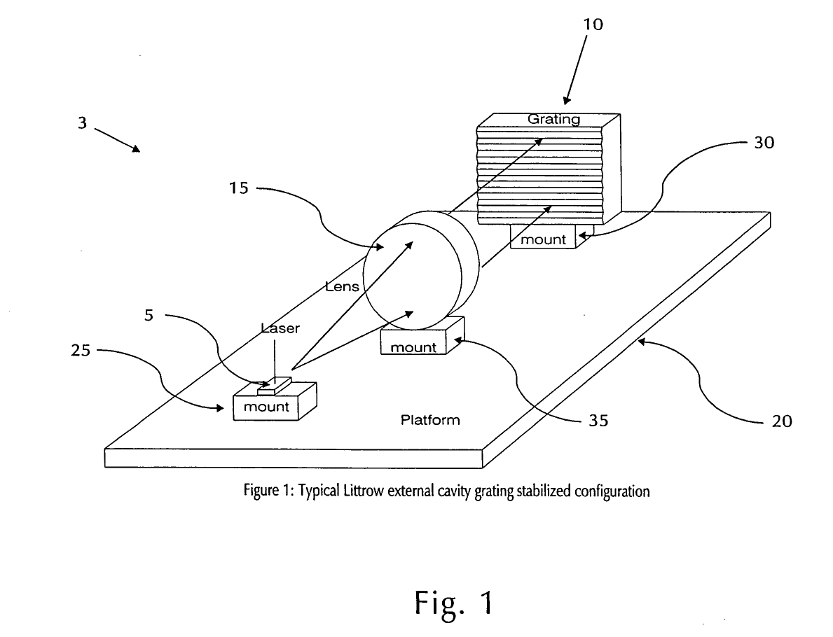

Looking first at FIG. 1, there is shown an external cavity wavelength stabilized laser system 3 which exemplifies the typical geometry for an external cavity wavelength stabilized laser system. In this geometry, the wavelength of a laser 5 is set by the diffraction grating 10, by virtue of the diffraction feedback coming off the diffraction grating and back into the laser. A lens 15 is positioned between laser 5 and diffraction grating 10 in order to focus the light rays. The laser 5, the diffraction grating 10 and the lens 15 are all attached to a platform (or substrate) 20 by means of mounts 25, 30 and 35, respectively.

More particularly, with the external cavity wavelength stabilized laser geometry shown in FIG. 1, the wavelength of the laser is set by the equation:
mλG=Sin(α)−Sin(β)
where “m” is the order of diffraction, “G” is the number of grating grooves per unit length, α is the angle of incidence on the grating, and β is the angle of diffraction from the grating. Lasing is established for the wavelength that allows the maximum diffraction hack to the laser. This condition of equality of α and β means that the laser wavelength is determined by the angle that the grating is forming with the collimated laser output. This type of external cavity laser geometry is commonly known as Littrow geometry, and the particular incident angle (α_{L}) is commonly referred to as the Littrow angle.
m.λ.G=2 Sin(α_{L})→λ=2. Sin(α_{L})/m.G

This Littrow geometry is sensitive to temperature.

One effect of wavelength temperature sensitivity is through the change in the diffraction angle necessary to satisfy the condition of equality of (i) the incident angle of a beam coming from the laser and impinging on the grating, with (ii) the diffraction angle of a beam coming back to the laser emitting facet. Obviously differential temperature expansions of the laser mount 25, lens mount 35 and grating mount 30 can cause this angle to change, thus resulting in a shift of the laser wavelength.

Another effect of temperature on wavelength is through thermal expansion of the grating pitch density G. In other words, as the temperature of the diffraction grating changes, the pitch of the grating's grooves changes, thus leading to a shift of the laser wavelength.

In summary, then, with the Littrow geometry, changes in temperature tend to result in changes in wavelength due to two effects. The first is a change in the Littrow angle through differential temperature expansion of the laser mount, the lens mount and/or the grating mount, and/or the lens and laser material; and the second is the thermal expansion of the grating material itself which affects the grating pitch density G.

In accordance with the present invention, it has been discovered that temperature insensitive wavelength stabilization can be achieved by carefully balancing these two effects. More particularly, by carefully choosing the laser mount, the lens mount and the grating mount materials and their dimensions, as well as the lens material and its dimensions, the laser wavelength shift due to these net thermal expansions can effectively cancel the laser wavelength shift due to thermal changes in the grating pitch density G. In practice, we have applied this new technique in Raman laser assemblies operating at 785 nm wavelength to render the peak wavelength stable to within 0.02 nm from −10 degrees C. to +60 degrees C.

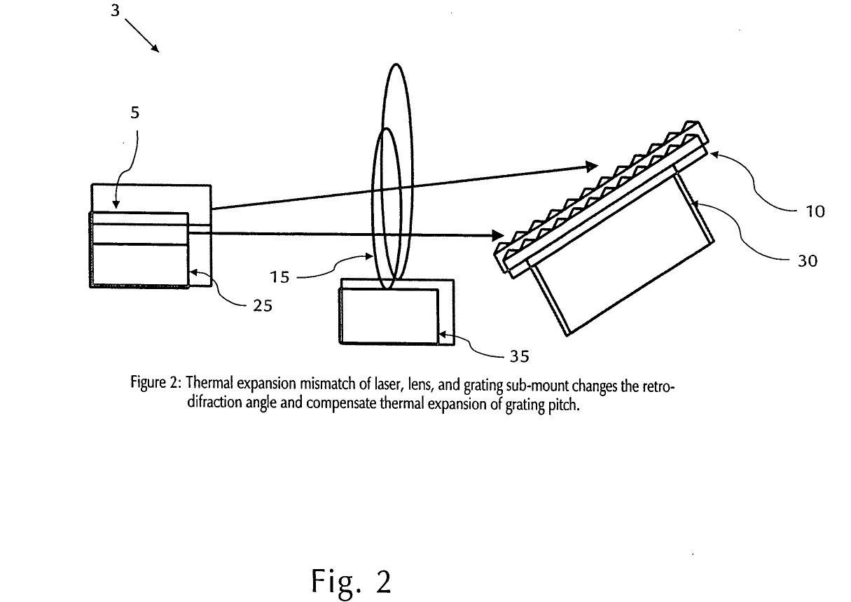

One manifestation of this idea is schematically illustrated in the external cavity wavelength stabilized laser system 3 shown in FIG. 2. In essence, the present invention uses differential changes in temperature expansions of the various system elements to change the Littrow angle, so as to cancel out temperature-induced changes in the pitch of the diffraction grating's grooves. As a result, the laser geometry is substantially insensitive to temperature changes because the thermal expansion of the laser mount 25, lens 15, lens mount 35 and grating mount 30 can compensate for the thermal expansion of the grating pitch.

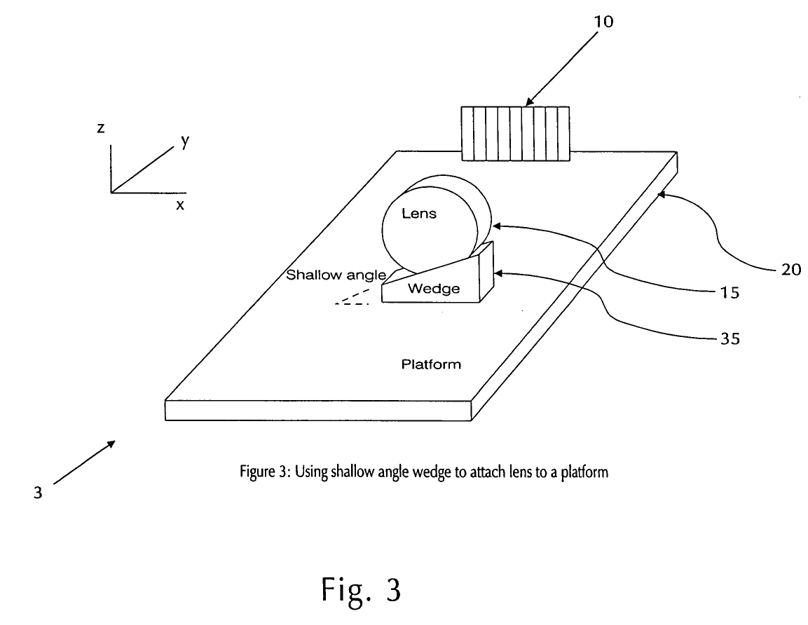

In another implementation of the present invention, and looking now at FIG. 3, there is shown an external cavity wavelength stabilized laser system 3 wherein a wedge-shaped mount 35 is used to attach lens 15 to the platform 20. As a result of this construction, if the angle of the wedge is small (e.g., <45 degree), thermal expansion of the wedge will mainly induce a lens motion in the vertical direction (i.e., the z direction in FIG. 3). Thus, if the diffraction grating 10 is arranged so that its grooves extend parallel to this vertical direction, any beam redirection due to thermally-induced lens motions will have relatively little effect on the Littrow angle. Accordingly, in this form of the invention, a wedge-shaped lens mount 35 is coordinated with the direction of the diffraction grating's grooves so as to reduce the effect of thermally-induced lens movement on the Littrow angle and thus stabilize the wavelength of the laser.

As noted above, the effect of thermal expansion of the diffractor (e.g., diffraction grating 10) and the resulting change in the diffraction characteristics of the diffractor (e.g., the thermal expansion of the grating pitch density G) inducing a shift of the laser wavelength may effectively be counterbalanced by the differential temperature expansions of the laser mount 25, lens mount 35 and/or grating mount 30. In this respect, it should be appreciated that differential temperature expansions of the laser mount 25, lens mount 35 and grating mount 30 may also be used to effectively counterbalance (i.e., offset) effects other than a change in the diffraction characteristics of the diffractor. Thus, if the diffraction grating is substantially insensitive to temperature, it can still be important to counterbalance the various effects temperature expansion of the various elements so as to maintain the Littrow angle. By way of example but not limitation, if temperature expansion of the laser mount 25 causes a change in the incident angle of the diffractor, the lens mount 35 may be configured to counterbalance this change in the incident angle of the diffractor so as to maintain the Littrow angle. It should be noted that any one or more of laser mount 25, lens mount 35 or grating mount 30 may act as a counterbalancing element for a change in the incident angle of the diffractor caused by another element.

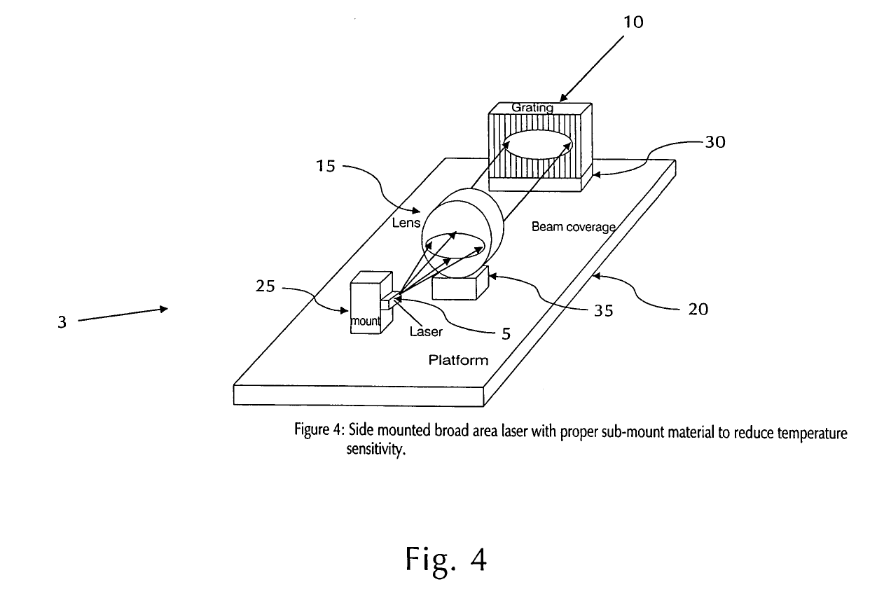

Looking next at FIG. 4, there is shown another external cavity wavelength stabilized laser system 3 which embodies a further implementation of the present invention. More particularly, to achieve high power laser operation (e.g., for use in Raman pump applications), wavelength stabilized broad area lasers are commonly used. Such lasers are commonly characterized by multiple transverse modes that have a single lateral mode operation. Although the techniques presented in this disclosure work well for single spatial mode lasers, their benefits are even more obvious for multiple transverse mode broad area lasers that have single lateral mode operation. Thus, and looking now at FIG. 4, if these broad area lasers 5 are mounted on their side such that the plane defined by the diverging angle of the lateral mode is parallel to the plane of the platform 20, and the grooves of the diffraction grating 10 extend perpendicular to the plane of the platform, the laser wavelength becomes relatively insensitive to to the vertical displacement of the laser mount 25, lens mount 35, and grating mount 30, and the vertical displacement of the laser chip 5 and lens 15. Of course, the grating pitch density may still change with temperature, thus effecting laser wavelength. However, by properly choosing the material of the laser mount 25 so that it will cancel the effect of the grating pitch density change on wavelength, a temperature-insensitive operation can be achieved. With the side-mounted geometry shown in FIG. 4, a laser mount material can be chosen so as to cancel the grating pitch density change effect on laser wavelength for a relatively large temperature range. In practice, this technique has been applied to a broad area laser emitting more than 500 mW at 785 nm to achieve less than 0.02 nm wavelength shift for a temperature range from −10 degrees C. to +60 degrees C., by using copper as the laser mount material with standard grating material.

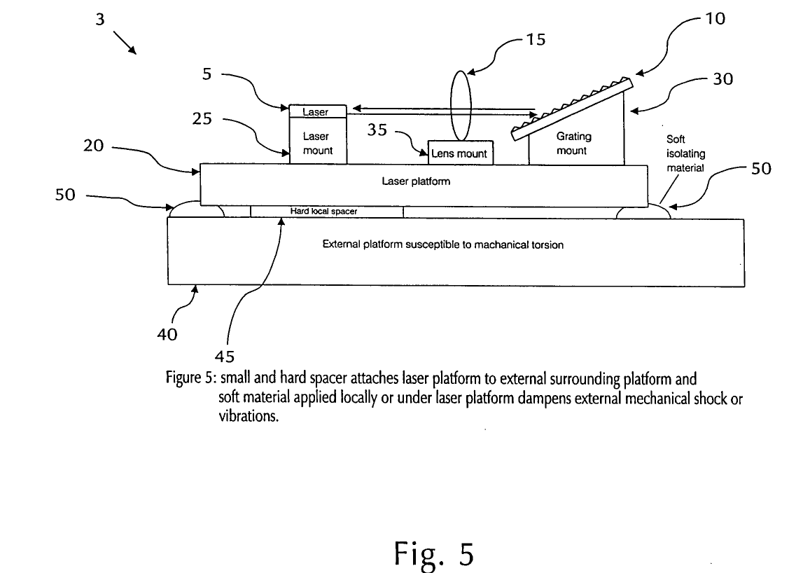

Looking next at FIG. 5, there is shown another external cavity wavelength stabilized laser system 3 which embodies a further implementation of the present invention. More particularly, if the laser platform 20 mechanically deforms due to external stress (either temperature or mechanicanically induced), misalignment of the system components can occur, resulting in a change of the Littrow angle and thus affecting the external cavity laser wavelength. To this end, the laser platform 20 can be, to at least some extent, mechanically isolated from the outside (e.g., from the external platform 40) by using a relatively small, thin, hard local spacer 45 and segments of soft isolating material 50. The hard local spacer 45 provides relatively rigid mechanical attachment to the outside world through the externally supplied platform 40 (i.e., chassis) and can be thermally conductive so as to heat-sink the laser 5 (in which case the spacer 45 is preferably attached directly beneath the laser mount 25). The segments of soft isolating material 50 serve as shock/vibration absorbers to dampen external forces, and may comprise epoxy or similar materials. Thus, in this aspect of the invention, the laser platform 20 is attached to an external platform 40 via (i) a small, hard and potentially thermally conductive spacer 45, and (ii) segments of soft material 50, so as to reduce the effect of mechanical deformations and distortions on the wavelength of the external cavity laser.

The present disclosure discusses the present invention in the context of an external cavity grating stabilized laser, although the concepts of this invention also apply to thin-film wavelength stabilized lasers.

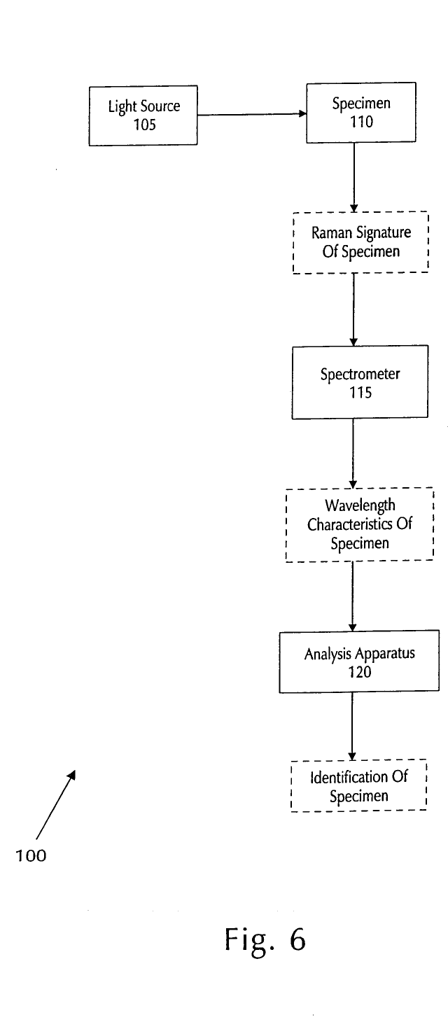

It is possible to utilize the novel external cavity temperature stabilized laser of the present invention in many applications. It is particularly useful a portable applications requiring stable, narrow-linewidth light signals. Thus, for example, in FIG. 6 there is shown novel Raman analyzer 100 formed in accordance with the present invention. Raman analyzer 100 generally comprises a light source 105 for delivering excitation light to a specimen 110 so as to generate the Raman signature for that specimen, a spectrometer 115 for receiving the Raman signature of the specimen and determining the wavelength characteristics of that Raman signature, and analysis apparatus 120 for receiving the wavelength information from spectrometer 115 and, using the same, identifying specimen 110. In accordance with the present invention, light source 105 comprises an uncooled, external cavity wavelength stabilized laser formed in accordance with the present invention. By way of example, light source 105 may comprise a laser system such as that shown in FIGS. 1-5. By virtue of the fact that the Raman analyzer 100 utilizes the uncooled, external cavity wavelength stabilized laser system of the present invention, the entire Raman analyzer can be made more power efficient, which is a significant advantage in handheld applications.

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. An external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
wherein the system components are selected so that (i) a change in the angle of incidence of the light on the diffractor due to a change in the temperature of the system components substantially offsets (ii) a change in the diffraction characteristics of the diffractor.

2. An external cavity wavelength stabilized laser system according to claim 1 wherein the laser is characterized by a single spatial mode of operation.

3. An external cavity wavelength stabilized laser system according to claim 1 wherein the laser is characterized by multiple transverse modes that have a single lateral mode of operation.

4. An external cavity wavelength stabilized laser system according to claim 1 wherein the diffractor is a diffraction grating.

5. An external cavity wavelength stabilized laser system according to claim 4 wherein the grooves of the diffraction grating extend parallel to the plane of the platform.

6. An external cavity wavelength stabilized laser system according to claim 4 wherein the grooves of the diffraction grating extend perpendicular to the plane of the platform.

7. An external cavity wavelength stabilized laser system according to claim 1 wherein the diffractor is a thin film dispersive filter.

8. An external cavity wavelength stabilized laser system according to claim 1:
wherein the laser and the diffractor are determined by system requirements; and
wherein at least one of the laser mount, the lens mount, the diffractor mount and the lens is selected so that (i) a change in the angle of incidence of the light on the diffractor due to a change in the temperature of the system components substantially offsets (ii) a change in the diffraction characteristics of the diffractor.

9. An external cavity wavelength stabilized laser system according to claim 1:
wherein the lens mount is substantially wedge shaped;
wherein the diffractor is a diffraction grating; and
wherein the grooves of the diffraction grating extend perpendicular to the plane of the platform.

10. An external cavity wavelength stabilized laser system according to claim 1:
wherein the laser is characterized by multiple transverse modes that have a single lateral mode of operation;
wherein the laser is side mounted to the laser mount so that the plane defined by the diverging angle of the lateral mode is substantially parallel to the plane of the platform;
wherein the diffractor is a diffraction grating; and
wherein the grooves of the diffraction grating extend perpendicular to the plane of the platform.

11. An external cavity wavelength stabilized laser system according to claim 1 wherein the platform is attached to an external platform by (i) a small hard spacer intermediate the length of the platform, and (ii) at least one segment of relatively soft isolating material outboard of the spacer.

12. An external cavity wavelength stabilized laser system according to claim 11 wherein the platform is attached to the external platform by at least two segments of relatively soft isolating material outboard of the spacer.

13. An external cavity wavelength stabilized laser system according to claim 11 wherein the spacer is disposed substantially below the laser.

14. An external cavity wavelength stabilized laser system according to claim 14 wherein the spacer comprises a thermally conductive material so as to act as a heat sink for the laser.

15. A Raman analyzer comprising:
a light source for delivering excitation light to a specimen so as to generate the Raman signature for that specimen;
a spectrometer for receiving the Raman signature of the specimen and determining the wavelength characteristics of that Raman signature; and
analysis apparatus for receiving the wavelength information from the spectrometer and, using the same, identifying the specimen;
wherein the light source comprises an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
wherein the system components are selected so that (i) a change in the angle of incidence of the light on the diffractor due to a change in the temperature of the system components substantially offsets (ii) a change in the diffraction characteristics of the diffractor.

16. An external cavity wavelength stabilized laser system according to claim 15:
wherein the laser and the diffractor are determined by system requirements; and
wherein at least one of the laser mount, the lens mount, the diffractor mount and the lens is selected so that (i) a change in the angle of incidence of the light on the diffractor due to a change in the temperature of the system components substantially offsets (ii) a change in the diffraction characteristics of the diffractor.

17. An external cavity wavelength stabilized laser system according to claim 15:
wherein the lens mount is substantially wedge shaped;
wherein the diffractor is a diffraction grating; and
wherein the grooves of the diffraction grating extend perpendicular to the plane of the platform.

18. An external cavity wavelength stabilized laser system according to claim 15:
wherein the laser is characterized by multiple transverse modes that have a single lateral mode of operation;
wherein the laser is side mounted to the laser mount so that the plane defined by the diverging angle of the lateral mode is substantially parallel to the plane of the platform;
wherein the diffractor is a diffraction grating; and
wherein the grooves of the diffraction grating extend perpendicular to the plane of the platform.

19. A method for generating light, comprising:
providing an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
selecting the system components so that (i) a change in the angle of incidence of the light on the diffractor due to a change in the temperature of the system components substantially offsets (ii) a change in the diffraction characteristics of the diffractor.

20. An external cavity wavelength stabilized laser system according to claim 19:
wherein the laser and the diffractor are determined by system requirements; and
wherein at least one of the laser mount, the lens mount, the diffractor mount and the lens is selected so that (i) a change in the angle of incidence of the light on the diffractor due to a change in the temperature of the system components substantially offsets (ii) a change in the diffraction characteristics of the diffractor.

21. An external cavity wavelength stabilized laser system according to claim 19:
wherein the lens mount is substantially wedge shaped;
wherein the diffractor is a diffraction grating; and
wherein the grooves of the diffraction grating extend perpendicular to the plane of the platform.

22. An external cavity wavelength stabilized laser system according to claim 19:
wherein the laser is characterized by multiple transverse modes that have a single lateral mode of operation;
wherein the laser is side mounted to the laser mount so that the plane defined by the diverging angle of the lateral mode is substantially parallel to the plane of the platform;
wherein the diffractor is a diffraction grating; and
wherein the grooves of the diffraction grating extend perpendicular to the plane of the platform.

23. A method for identifying a specimen, comprising:
delivering excitation light to the specimen so as to generate the Raman signature for that specimen;
receiving the Raman signature of the specimen and determining the wavelength characteristics of that Raman signature; and
identifying the specimen using the wavelength characteristics of the Raman signature;
wherein the excitation light is delivered to the specimen using an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
wherein the system components are selected so that (i) a change in the angle of incidence of the light on the diffractor due to a change in the temperature of the system components substantially offsets (ii) a change in the diffraction characteristics of the diffractor.

24. An external cavity wavelength stabilized laser system according to claim 23:
wherein the laser and the diffractor are determined by system requirements; and
wherein at least one of the laser mount, the lens mount, the diffractor mount and the lens is selected so that (i) a change in the angle of incidence of the light on the diffractor due to a change in the temperature of the system components substantially offsets (ii) a change in the diffraction characteristics of the diffractor.

25. An external cavity wavelength stabilized laser system according to claim 23:
wherein the lens mount is substantially wedge shaped;
wherein the diffractor is a diffraction grating; and
wherein the grooves of the diffraction grating extend perpendicular to the plane of the platform.

26. An external cavity wavelength stabilized laser system according to claim 23:
wherein the laser is characterized by multiple transverse modes that have a single lateral mode of operation;
wherein the laser is side mounted to the laser mount so that the plane defined by the diverging angle of the lateral mode is substantially parallel to the plane of the platform;
wherein the diffractor is a diffraction grating; and
wherein the grooves of the diffraction grating extend perpendicular to the plane of the platform.

27. An external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
wherein the system components are selected so that a change in the position of one element in the system due to a temperature change is offset by a change in the position of another element in the system due to a temperature change so as to substantially maintain the angle of incidence of the light on the diffractor.

28. A method for generating light, comprising:
providing an external cavity wavelength stabilized laser system comprising:
a platform;
a laser mounted to the platform with a laser mount;
a diffractor mounted to the platform with a diffractor mount; and
a lens mounted to the platform with a lens mount between the laser and the diffractor so as to transmit light therebetween;
wherein the wavelength of the laser is determined by (i) the angle of incidence of the light on the diffractor, and (ii) the diffraction characteristics of the diffractor; and
selecting the system components so that a change in the position of one element in the system due to a temperature change is offset by a change in the position of another element in the system due to a temperature change so as to substantially maintain the angle of incidence of the light on the diffractor.
